(19) United States
(12) Patent Application Publication
(10) Pub. No.: US 2009/0271329 A1
(43) Pub. Date: Oct. 29, 2009

(54) UTILITY MANAGEMENT SYSTEM

(76) Inventor: Akiyoshi Mohri, Kobe-shi (JP)

Correspondence Address: KATTEN MUCHIN ROSENMAN LLP, 575 MADISON AVENUE, NEW YORK, NY, 10022-2585, US

(21) Appl. No.: 12/109,535

(22) Filed: Apr. 25, 2008

(51) Int. Cl. G06Q 40/00; G06F 17/40

(52) U.S. Cl. 705/36 R; 702/187

(57) ABSTRACT

A utility management system is provided that makes it possible for an Internet user to more easily know the status of his/her own utility usage in realtime. An AMR (Automated Meter Reader) system and ISP (Internet Service Provider) include means for sending digital data that indicates the status of utility usage from the AMR system to the ISP in realtime; and the ISP includes means for converting the digital data to content information, and means for the Internet user to log into the ISP and obtain the content information, so the subscriber is able to know the status of his/her own utility usage in realtime.

### BACKGROUND OF THE INVENTION

The present invention relates to a utility management system in which a user can know and manage in realtime the condition of usage of his/her utilities.

A very effective way to help curb global warming would be for all humans to individually reduce their own emissions of greenhouse gases without relying on international conferences, domestic policies or the like. However, it is very difficult to know how much can be contributed by improving ones own lifestyle.

The amount of emissions of greenhouse gases is proportional to the amount of use of utilities such as electric power, gas and water. With the aim of economical conservation, various techniques have been disclosed regarding systems that make it possible to know in realtime the status of utility usage.

For example, Japanese patent application publication No. H7-226882 discloses a system in which meters such as an electric power meter, water meter and gas meter are connected to a gas security panel that is located in each home, and the respective meter data is read, stored in memory and accumulated, and the amount of use of each utility and the cost of each are displayed in realtime on a display device that is connected to the security panel. Moreover, Japanese patent application publication No. 2003-50626 discloses an energy control system in which the amount of electricity, gas, water, etc. that is used is measured and compared with amounts used in the past, and when an amount exceeds a preset target value for saving energy, an alarm is sounded and the load is shut off. However, this information can only be obtained from a special display device that is installed in a user's home, and at a location away from that display device, regardless of whether inside or outside the user's home, it is difficult to obtain information in realtime. In addition, there is a problem in that there is a cost for using this kind of special display device.

Japanese patent application publication No. 2005-130137 discloses a method of using realtime information for managing energy on the user side, in which a terminal at a control center is connected over a network to measurement devices for each of the utilities and when a user connects his terminal to the terminal at the control center over the network and accesses a homepage, the user is able to know in realtime at any time the fees for the respective utilities. However, this system is an internal system of a business facility, and similar to the other cases described above, at a location away from the business facility, it is difficult to obtain the information in realtime. In addition, adopting this system to individual households would probably be impossible due to problems related to the scale and cost of the system.

However, in this system it is necessary that for each utility service provider, the database located on the provider's server and the user's communication terminal be connected over a communication network. Moreover, in this system, even when using IP (Internet Protocol) communication, it is necessary to enter the site for each utility service provider separately from a portal site, and to input the necessary information for each provider, and after verification has been received it is possible to receive the data. Furthermore, there is a problem in that the user is not able to manage all the data together.

On the other hand, there is an AMR (Automated Meter Reader) system as a system for automatically checking the amount of usage of utilities in each home. AMR remotely reads the meters for all of the user's utilities, and notifies a settlement system of the read data using a communication network.

In U.S. Pat. No. 6,559,766 the inventor proposes an in-home surveillance system that employs automatic reading by using IP (Internet Protocol) communication to send the status of utility usage from a home-use cable modem that is connected to the AMR system to a center that is connected to the Internet.

However, in this system as well, the automatically read information may be used in the detection of each user's unusual conditions, however is not returned as feedback online to each user.

### SUMMARY OF THE INVENTION

The object of the present invention is to provide a utility management system that makes it possible for a user to more easily know in realtime the status of his/her own utility usage, and helps the user to make a more effective contribution in curbing global warming.

In other words, the utility management system of the present invention makes it possible for an Internet user to know in realtime information related to the status of his/her own utility usage, wherein an AMR (Automated Meter Reader) system and ISP (Internet Service Provider) comprise means for sending digital data that indicates the status of utility usage from the AMR system to the ISP in realtime; and the ISP comprises: means for converting the digital data to content information, and means for the Internet user to log into the ISP and obtain the content information.

It is preferred that the ISP be part of a cable TV system or a mobile telephone connection system.

Moreover, it is preferred that the means for obtaining content information be portal sites that the ISP provides to the Internet user; and by logging into these portal sites, the Internet user be able to access information related to the status of utility usage.

Or it is preferred that means for obtaining the content information be personal portal sites that the ISP provides to the Internet user; and by logging into these personal portal sites, the Internet user be able to access information related to the status of utility usage.

Furthermore, it is preferred that the means for converting the digital data to content information calculate the amount of carbon dioxide gas emissions of the Internet user from digital data that indicates the status of utility usage, and provide the calculated data to the Internet user as information related to the status of utility usage.

In this case, it is preferred that the utility management system further comprise means for storing data related to carbon dioxide gas emissions for specified periods of time set or selected by the user, comparing the calculated amounts of carbon dioxide gas emission based on the actual status of utility usages for each of the specified periods of time, and investing in investments related to measures against global warming based on excess amounts after a preset period of time.

### EFFECT OF THE INVENTION

In the utility management system of the present invention, the ISP comprises means for an Internet user who logged into the ISP to obtain content information, whereby differing from the prior art, the information is accessed at the same time that cable TV or a mobile telephone is connected, such that it becomes possible for the Internet user to know the status of his/her own utility usage in realtime, and thus the present invention helps each individual to effectively contribute to the curbing of global warming.

For example, an Internet user that receives Internet service from cable television accesses the homepage (portal site) of the cable television business via the cable television Internet service and logs in, and by installing an AMR device, is able to check the status of his/her own infrastructure in realtime via a communication device such as a personal computer or a mobile telephone regardless of location.

Furthermore, with the present invention, ISPs, including cable television companies, are able to provide new services for their own portal sites, and together with increasing the added value of their services, are able to create new business models based on that information.

### BRIEF DESCRIPTION OF THE DRAWINGS

FIG. 1 is a drawing showing the overall construction of the utility management system of the present invention.

FIG. 2 is a drawing showing an example of a personal portal site screen.

FIG. 3 is a drawing showing an example of a display that shows comparisons of the amount of carbon dioxide gas emissions at specified periods of time.

### DESCRIPTION OF THE PREFERRED EMBODIMENTS

FIG. 1 is a drawing showing the overall construction of the utility management system of the present invention.

In the utility management system of the present invention: an AMR system and ISP comprise means for sending digital data that indicates the status of utility usage from the AMR system to the ISP in realtime; and the ISP comprises: means for converting that digital data to content information in the ISP; and means for an Internet user that is logged into the ISP to obtain the content information; so that it is possible for the Internet user to know in realtime the status of his/her own utility usage.

More specifically, the digital data that indicates the status of utility usages could be the amount of electric power (kW) that is measured instantaneously by an electric meter, or the amount of electric power (kW) that is the amount of electric power used per unit time (kWh) that is measured by the electric meter and divided by the unit time. The digital data could also be the amount of gas flow (m³/h) that is measured instantaneously by a gas meter, or could be the amount of gas flow (m³/h) that is the amount of gas flow power unit time (m³) that is measured by the gas meter that is divided by the unit time. Moreover, the digital data could be the amount of water flow (m³/h) that is measured instantaneously by a water meter, or could be the amount of water flow (m³/h) that is the amount of water usage per unit time (m³) that is measured by a water meter and that is divided by the unit time.

A device for automating the reading of these meters is a well-known AMR system, so by using a well-known device that uses this kind of AMR system for the electric meter, gas meter and water meter, it is possible to automatically read the meters in realtime.

The digital data that is acquired by the AMR system can be sent to an ISP over a cable television network or IP network by connecting the device for the AMR system to a home-use cable modem, for example.

Other utilities such as heating oil that is used in a heater, gasoline or diesel oil that is used in the family automobile, burnable garbage, etc., could also be considered. Moreover, in the case of generating energy using a solar battery system and supplying energy to the electric power company, this could be considered as factors moving toward reducing the amount of utility usage. More specifically, a device for the AMR system described above is connected to part of the supply line from the heating oil, gasoline or diesel oil storage tank, part of a solar battery system or part of a system that measures the amount of domestic garbage. In the case where gasoline is not stored at home, that can be reflected by sending the related information to the ISP over an IP network from the communication terminal of the Internet user. In this case, it is preferred that a verification system be used in order to reflect accurate facts.

In this specification for the present invention, the utilities referred to are generally, electricity, gas and water of which automatic meter reading by a well-known AMR system is possible, however, as described above, the utilities are not limited to these.

The digital data related to the utilities of each of the Internet users, which was sent over the IP network, is recorded in a database on a server on the side of the ISP. That digital data can also be connected via the IP network to the accounting system of the utility suppliers of each of the users.

At the ISP there is means for converting the digital data to content information, and by using the server and/or software the data is converted to various displayable data based on the data stored in the database.

For example, as shown in FIG. 3, based on digital data that is obtained in realtime, it is possible to express the utility usage of all utilities using a line graph, or the like.

Moreover, data after each interval of a specified period of time, for example one day, one week or one month, can be displayed for comparison. Conversion to these kinds of data can be achieved by using existing software, or of course special software could be newly developed.

More specifically, the means for converting digital data to content information can use the digital data that indicates the status of utility usage as is, or in order to achieve an actual feeling of reducing greenhouse gases, which is the object of the present invention, it is also effective to express the data as the volume or mass of reduced carbon dioxide gas, or to convert to a value on a global scale by dividing the value by the number of people in the family and then multiplying the result by the world population. It is possible to use a value that is always constant as the coefficient for conversion, or to use a value that is obtained from reflecting technological innovations.

These conversions can be performed according to greenhouse gas emission calculation methods that are provided by related organizations such as the governments of respective countries. For example, in Japan, it is possible to base conversion based on values that are listed in the ‘Review Period Results Related to Calculation Methods of Greenhouse Gas Emissions’ by the Ministry of the Environment, Greenhouse Gas Emissions Calculation Review Board.

By including data recorded in the past together with the most recent data, the invention is effective in making it possible to get a better feel of the contribution to the prevention of global warming, or making it possible to know what lifestyle habits must be improved.

Portal sites provided by the ISP are means for an Internet user who is logged into the ISP to obtain the content information. These portal sites are well known, and can be viewed by connecting a communication terminal such as a personal computer or mobile telephone of the Internet user to the communication server of the ISP by way of the IP network and the like.

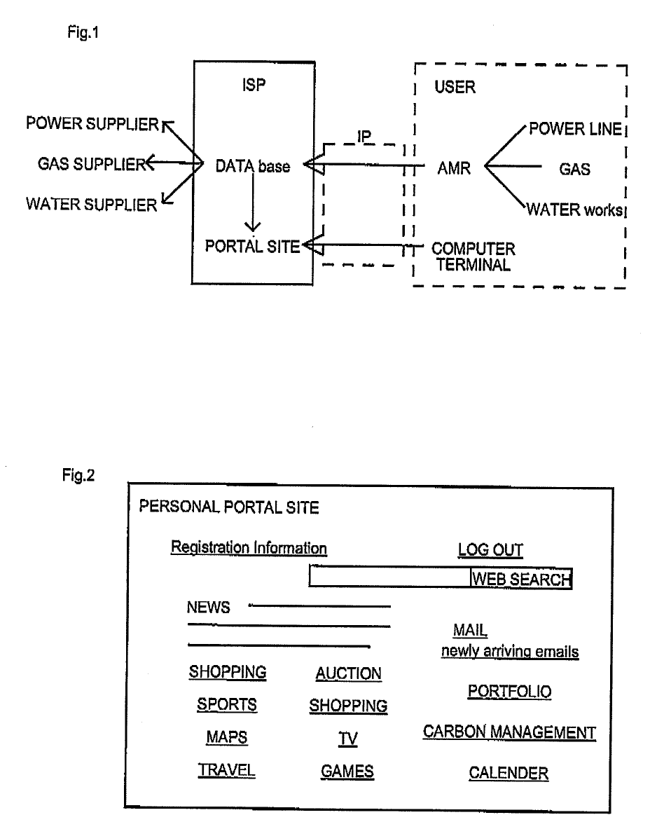

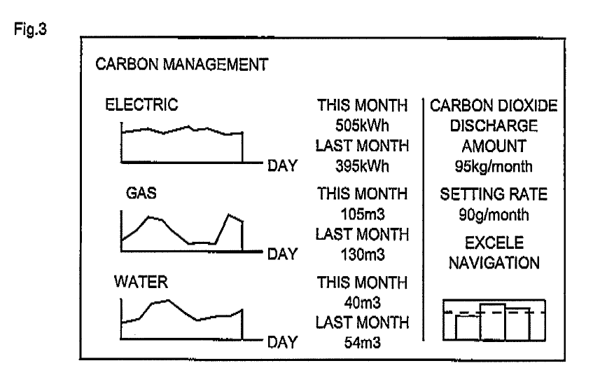

At these portal sites, by inputting a specific ID and preset PIN number, it becomes possible to obtain information that is unique to the user. Therefore, by inputting the ID and PIN number, an Internet user can connect to the user's homepage related to utilities as shown, for example, in FIG. 3, and view the information from their mobile terminal and the like. Moreover, as shown in FIG. 2, when a portal site is provided for each user, a tag such as ‘Carbon Management’ can be displayed on the homepage, and by clicking on that tag, the user can connect to their homepage.

The Internet user sets target setting values as the specified amounts of carbon dioxide emissions for each user, or target setting values are set for each user based on target setting values for the amount of carbon dioxide emission that are set according to the condition of the country so as to reflect the scale of the home, the location of the home, the environment of the home or the like, or target setting values are set from these values according to the national government, local public authority, or other related organization, and that data is stored in the ISP database.

As shown, for example, in FIG. 3, displaying data for the most recent three months, is effective in making it possible to get an even better feel of the contribution to the prevention of global warming, or making it possible to know what lifestyle habits must be improved.

Furthermore, it is preferred that there be means for storing data related to the carbon dioxide emission for each specified period of time that is set or selected by the Internet user in the ISP and comparing that data with the amount of carbon dioxide emission that is calculated based on the status of actual utility usage for each specified period of time, and based on the excess amount after a preset period of time, investing in an investment fund for taking measures against global warming.

More specifically, the ISP ties up with a securities company or the like, for example, and the ISP server connects by way of a dedicated communication line or an IP network with a system of the securities company that buys and sells investments related to measures against global warming. Moreover, the server can invest in these kinds of investments under the name of the service user according to the accumulated total of surplus amounts over a specified period of time such as one year. Also, a reference value can be set, and when the accumulated total of surplus amount reaches a reference value, it is possible for the server to make a similar investment. When buying or selling investments, settlement of the fee can be performed by adding the charge to the cable television fee or ISP usage fee, or can be performed by an existing settlement system that performs settlement individually using the credit card of the Internet user.

By making investments in businesses that control the carbon dioxide gas emissions in accordance to excess amounts of carbon dioxide gas emission by each service user in this way, it is possible to contribute to the curbing of gas emissions in a form similar to emissions trading.

The business model described above is one example, and it is possible for the cable television company or ISP to provide various services or create a new business model based on the utility management system of the present invention.

As was described above, it is possible for the Internet user to enjoy the benefit of having no special processing fees, as well as it is possible for the user to access and know his/her own data related to utility usage without the need for any special equipment except for the AMR equipment, and regardless of location. Moreover, the invention makes it possible for a connection company such as cable TV company or mobile telephone company to provide appealing new services, as well as create new business models based on the system, whereby the system of this invention can greatly contribute to industry.

What is claimed is:

1. A utility management system that makes it possible for an Internet user to know in realtime information related to the status of his/her own utility usage, wherein
an AMR (Automated Meter Reader) system and ISP (Internet Service Provider) comprise means for sending digital data that indicates the status of utility usage from the AMR system to the ISP in realtime; and
the ISP comprises means for converting the digital data to content information, and means for the Internet user to log into the ISP and obtain the content information.

2. The utility management system of claim 1, wherein the ISP is part of a cable TV system.

3. The utility management system of claim 1, wherein the ISP is part of a mobile telephone connection system.

4. The utility management system of claim 1, wherein the means for obtaining content information are portal sites that the ISP provides to the Internet user; and by logging into these portal sites, the Internet user is able to access information related to the status of utility usage.

5. The utility management system of claim 1, wherein means for obtaining the content information are personal portal sites that the ISP provides to the Internet user; and by logging into these personal portal sites, the Internet user is able to access information related to the status of utility usage.

6. The utility management system of claim 1, wherein means for converting the digital data to content information calculates the amount of carbon dioxide gas emissions of the Internet user from digital data that indicates the status of utility usage, and provides the calculated data to the Internet user as information related to the status of utility usage.

7. The utility management system of claim 6 further comprising means for storing data related to carbon dioxide gas emissions for specified periods of time set or selected by the user, comparing the calculated amounts of carbon dioxide gas emission based on the actual status of utility usages for each of the specified periods of time, and investing in investments related to measures against global warming based on excess amounts after a preset period of time.
